(19) United States
(12) Patent Application Publication
(10) Pub. No.: US 2019/0050940 A1
(43) Pub. Date: Feb. 14, 2019

(54) System and method for expedited liquidation for peer to peer securities

(71) Applicant: David A. Fluker, Port Allen, LA (US)

(72) Inventor: David A. Fluker, Port Allen, LA (US)

(21) Appl. No.: 15/847,357

(22) Filed: Dec. 19, 2017

Related U.S. Application Data
(60) Provisional application No. 62/436,393, filed on Dec. 19, 2016.

(51) Int. Cl. G06Q 40/04; G06Q 40/06; G06Q 40/02

(52) U.S. Cl. CPC G06Q 40/04; G06Q 40/025; G06Q 40/06

(57) ABSTRACT

This invention is a liquidity solution for the peer to peer lending market. Through the use of distributed computing networks, a defined community of investors is able to provide liquidity through a trading device as part of a pool of lenders who agree to pay standardized pre-set micro units across a set of loans. By arranging for these transactions in this manner, liquidity is enhanced for the original purchasers of peer to peer loans as well as for the community of lenders who agree to be part of the lending platform.

### CROSS REFERENCE TO RELATED APPLICATIONS

This application claims the priority of provisional application No. 62/436,393 filed on Dec. 19, 2016.

### REFERENCE TO GOVERNMENT FUNDING SOURCES

Not applicable.

### REFERENCE TO SEQUENCE LISTING

Not applicable.

### FIELDS OF THE INVENTION

The disclosure as detailed herein is in the technical field of financial industry applications. More specifically, the present disclosure relates to the technical field of client server management systems. Even more specifically, the present disclosure relates to the technical field of liquidity strategies for investments.

### DESCRIPTION OF RELATED ART

One relatively new form of investment are peer to peer securities. An example of these instruments are peer to peer loans in which a lender posts the information for loan applications and multiple investors collaborate to purchase micro portions of the loan in order to fulfill the loan request. A peer to peer lender builds a portfolio by taking fractional positions in one or more loans. By investing in small amounts of a series of loan it allows the investor to limit risk.

One problem faced by peer to peer lenders is the inability to reliably obtain cash liquidity. Generally, lenders are repaid fractions of a set of loans on a monthly basis and are not able to accelerate access to their entire investment should they wish to access capital. Significant liquidity problems in the secondary market for these loans has persisted across a variety of platforms. There are few buyers of existing loans on the secondary markets.

### GENERAL SUMMARY OF THE INVENTION

This invention is a liquidity solution for the peer to peer lending market. Through the use of distributed computing network a defined community of investors is able to provide liquidity by being part of pool of lenders who agree to pay standardized pre-set micro units across a set of loans.

These lenders also agree that iterative purchasing is directed at preferred sets of secondary market loans before the group originates new, previously unfunded loans. By arranging for these transactions in this manner, liquidity is enhanced for the original purchasers of peer to peer loans as well as for the community of lenders who agree to be part of the lending platform. Also, by being part of the community of lenders on the platform, purchasers gain access to seasoned loans which have more predictable value and payback rates.

These methods are primarily accomplished through one or more modules that implement algorithms that choose secondary matches based on community investor preferences for risk and performance history. Additional modules provide a layered diversification strategy in order to limit the downside of any one tranche of loans.

### DESCRIPTION OF FIGURES

FIG. 1 is a diagram that shows an exemplary hardware architecture of a computing device used in an embodiment of the invention.

FIG. 2 is a diagram that shows an exemplary logical architecture for a client device, according to an embodiment of the invention.

FIG. 3 is a diagram that shows an exemplary architectural arrangement of clients, servers, and external services, according to an embodiment of the invention that shows.

FIG. 4 is a diagram that shows an embodiment of a hardware architecture of a computing device used in various embodiments of the invention.

FIG. 5 is a diagram of the distributed computing network.

FIG. 6A is a diagram of the overall use of the system.

FIG. 6B is a diagram of the overall use of the system.

FIG. 6C is a diagram of the overall use of the system

FIG. 7 is a diagram of determining loan selection.

FIG. 8 is a diagram of loan scoring.

FIG. 9 is a diagram of determining MUI for trading system.

FIG. 10 is a diagram of connecting to trading platform.

FIG. 11 is a diagram of establishing risk tolerance.

FIG. 12A is a diagram of examining for prior investor group loans on the secondary market.

FIG. 12B is a diagram of examining for prior investor group loans on the secondary market.

FIG. 13 is a diagram of identifying position of member in first in first out system.

FIG. 14 is a diagram of selection of investor group notes.

FIG. 15 is a diagram of buying on the primary market.

FIG. 16 is a diagram of an embodiment of a diversification strategy for loan purchasing.

FIG. 17A is a diagram of an embodiment of a diversification strategy for secondary market loan purchasing.

FIG. 17B is a diagram of an embodiment of a diversification strategy for secondary market loan purchasing.

FIG. 18 is a diagram of an embodiment of a diversification strategy for loan purchasing for non-common secondary market loans.

### DETAILED DESCRIPTION

One or more different inventions may be described in the present application. Further, for one or more of the inventions described herein, numerous alternative embodiments may be described; it should be appreciated that these are presented for illustrative purposes only and are not limiting of the inventions contained herein or the claims presented herein in any way. One or more of the inventions may be widely applicable to numerous embodiments, as may be readily apparent from the disclosure. In general, embodiments are described in sufficient detail to enable those skilled in the art to practice one or more of the inventions, and it should be appreciated that other embodiments may be utilized and that structural, logical, software, electrical and other changes may be made without departing from the scope of the particular inventions. Accordingly, one skilled in the art will recognize that one or more of the inventions may be practiced with various modifications and alterations. Particular features of one or more of the inventions described herein may be described with reference to one or more particular embodiments or figures that form a part of the present disclosure, and in which are shown, by way of illustration, specific embodiments of one or more of the inventions. It should be appreciated, however, that such features are not limited to usage in the one or more particular embodiments or figures with reference to which they are described. The present disclosure is neither a literal description of all embodiments of one or more of the inventions nor a listing of features of one or more of the inventions that must be present in all embodiments.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an embodiment with several components in communication with each other does not imply that all such components are required. To the contrary, a variety of optional components may be described to illustrate a wide variety of possible embodiments of one or more of the inventions and in order to more fully illustrate one or more aspects of the inventions. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the invention(s), and does not imply that the illustrated process is preferred. Also, steps are generally described once per embodiment, but this does not mean they must occur once, or that they may only occur once each time a process, method, or algorithm is carried out or executed. Some steps may be omitted in some embodiments or some occurrences, or some steps may be executed more than once in a given embodiment or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments of one or more of the inventions need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process.

Alternate implementations are included within the scope of embodiments of the present invention in which, for example, functions may be executed out of order from that shown or discussed, including substantially concurrently or in reverse order, depending on the functionality involved, as would be understood by those having ordinary skill in the art.

Software/hardware hybrid implementations of at least some of the embodiments disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific embodiments, at least some of the features or functionalities of the various embodiments disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some embodiments, at least some of the features or functionalities of the various embodiments disclosed herein may be implemented in one or more virtualized computing environments (e.g., network computing clouds, virtual machines hosted on one or more physical computing machines, or other appropriate virtual environments).

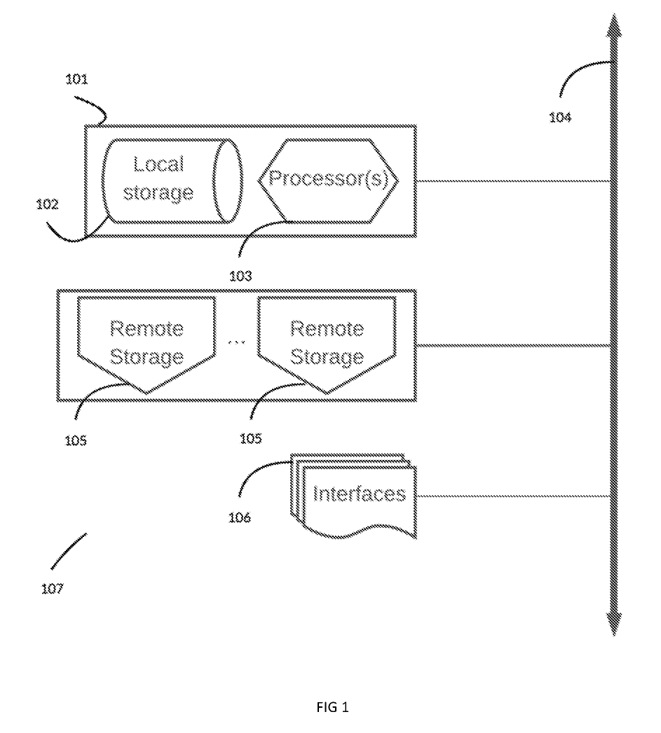

Referring now to FIG. 1, which shows a diagram that shows an exemplary hardware architecture of a computing device used in an embodiment of the invention. CPU 101 comprises a unit responsible for implementing specific functions associated with the functions of a specifically configured computing device 107 or machine. The central processing unit is an acronym which stands for CPU 101. In some embodiments, it is thought that examples of CPU 101 may include: system-on-a-chip (SOC) type hardware, Qualcomm SNAPDRAGON, or Samsung EXYNOS CPU. Local memory 102 comprises one or more physical devices used to store programs (sequences of instructions) or data (e g. program state information) on a temporary or permanent basis for use in a computer or other digital electronic device, which may be configured to couple to the system in many different configurations. In some embodiments, it is thought that examples of local memory 102 may include: non-volatile random access memory 205 (RAM), read-only memory 205 (ROM), or one or more levels of cached memory 205.

In some embodiments, it is thought that examples of processor 103 may include: field-programmable gate arrays (FPGAs), Intel processors, Qualcomm processors, AMD processors, application-specific integrated circuits (ASICs), electrically erasable programmable read-only memories (EEPROMs), ARM processors, mobile processors, microprocessors, microcontrollers, microcomputers, programmable logic controllers, or programmable circuits. Communications network 104 comprises a communications network 104 that allows computers to exchange data using known protocols. In some embodiments, it is thought that examples of communications network 104 may include: backbone area networks, wireless personal area networks, near-me area networks, local area networks, wireless local area networks, wireless mesh networks, wireless metropolitan area networks, wireless wide area networks, cellular networks, home area networks, storage area networks, campus area networks, personal area networks, metropolitan area networks, wide area networks, enterprise private networks, virtual private networks, intranets, extranets, Internetworks, Internets, near field communications, mobile telephone networks, CDMA networks, GSM cellular networks, or WiFi networks.

Remote memory 105 comprises a service that provides users with a system for the backup, storage, and recovery of data. Interface 106 comprises a mechanism to control the sending and receiving of data packets over a computer network or support peripherals used with the computing device 107. In some embodiments, it is thought that examples of interface 106 may include: BLUETOOTH interfaces, ethernet interfaces, frame relay interfaces, cable interfaces, DSL interfaces, token ring interfaces, graphics interfaces, universal serial bus (USB) interfaces, Serial port interfaces, Ethernet interfaces, FIREWIRE interfaces, THUNDERBOLT interfaces, PCI interfaces, parallel interfaces, radio frequency (RF) interfaces, network interface 106 cards (NICs), near-field communications interfaces, 802.11 (WiFi) interfaces, frame relay interfaces, TCP/IP interfaces, ISDN interfaces, fast Ethernet interfaces, Gigabit Ethernet interfaces, Serial ATA (SATA) or external SATA (ESATA) interfaces, high-definition multimedia interfaces (HDMI), digital visual interfaces (DVI), analog or digital audio interfaces, asynchronous transfer mode (ATM) interfaces, high-speed serial interface (HSSI) interfaces, Point of Sale (POS) interfaces, or fiber data distributed interfaces (FDDIs). Computing device 107 comprises an electronic device capable of executing software- or hardware-based instructions according to one or more programs stored in memory 205. In some embodiments, it is thought that examples of computing device 107 may include: notebooks, desktop computers, carputers, game consoles, laptops, palmtops, tablets, smartphones, smartbooks, or a server 301 system utilizing CPU 101, local memory 102, and/or remote memory 105, and interface 106.

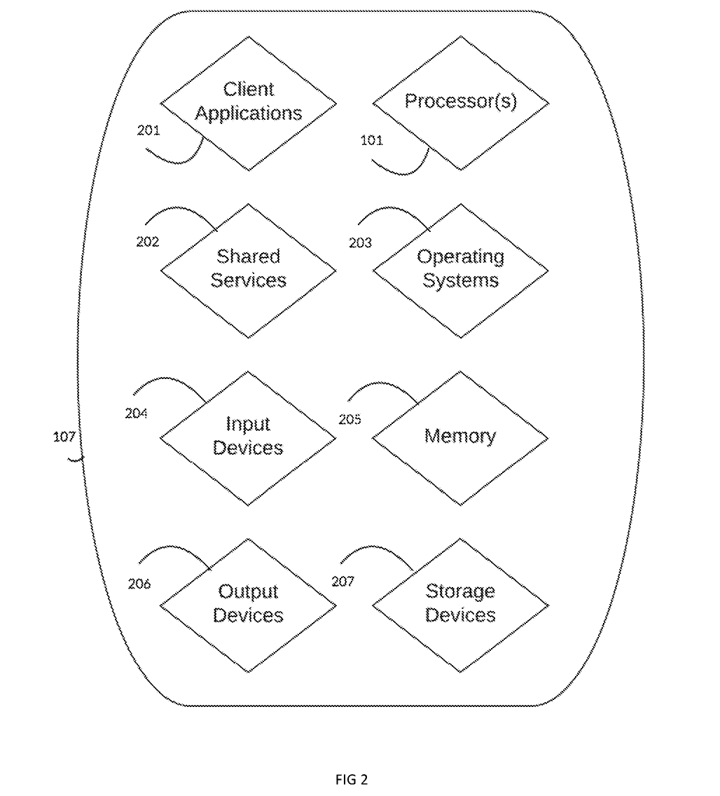

Referring now to FIG. 2, which shows a diagram that shows an exemplary logical architecture for a client device, according to an embodiment of the invention. Shared services 202 comprises web-enabled services or functionality related to a computing device 107. Operating systems 203 comprises system software that manages computer hardware and software resources and provides common services for computer programs. In some embodiments, it is thought that examples of operating systems 203 may include: Microsoft WINDOWS, Apple Mac OS/X, iOS operating systems, Linux operating systems, or Google ANDROID operating systems. Input devices 204 comprises device of any type suitable for receiving user input. Memory 205 comprises a mechanism designed to store program instructions, state information, and the like for performing various operations described herein, and may be storage devices 207, in some embodiments. In some embodiments, it is thought that examples of memory 205 may include: read-only memory 205 (ROM), read-only memory 205 devices (ROM), memristor memory, random access memory 205 (RAM), or RAM hardware modules. Output devices 206 comprises devices of any type suitable for outputting computing device 107 related information. In some embodiments, it is thought that examples of output devices 206 may include: screens for visual output, speakers, or printers. Storage devices 207 comprises mechanisms designed to store information which in some embodiments may be memory 205. In some embodiments, it is thought that examples of storage devices 207 may include: flash memory, hard disks, floppy disks, magnetic tape, optical media, CD-ROM disks, magneto-optical media, optical disks, magnetic media, solid state drives (SSD), “hybrid SSD” storage drives, swappable flash memory modules, thumb drives, hot-swappable hard disk drives, solid state drives, removable optical storage discs, or electrical storage devices.

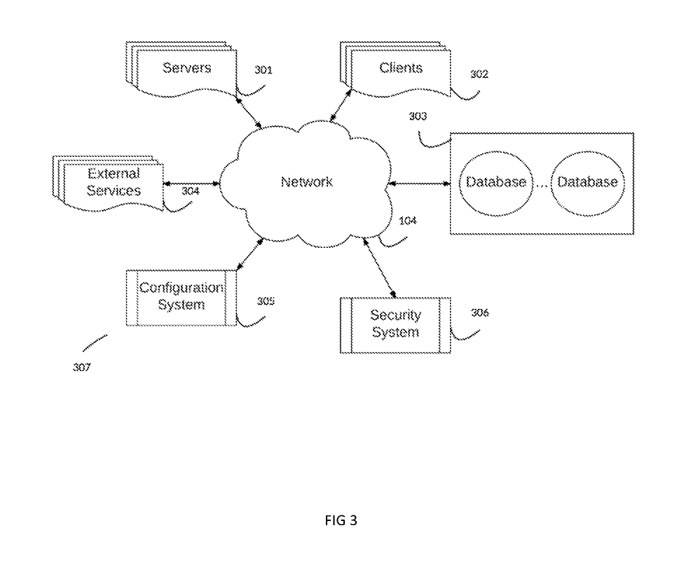

Referring now to FIG. 3, which shows a diagram that shows an exemplary architectural arrangement of clients, servers, and external services, according to an embodiment of the invention. Server 301 comprises a computing device 107 configured to handle requests received from one or more client 302 or other server 301 over a communications network 104. Client 302 comprises one or more computing device 107 with program instructions for implementing client-side portions of the present system, which in some embodiments, may be connected to a communications network 104. Database 303 comprises an organized collection of data within a program instructions related system, designed to allow the definition, creation, querying, update, and administration of database 303. In some embodiments, it is thought that examples of database 303 may include: relational database 303 systems, NoSQL systems, Hadoop systems, Cassandra systems, Google BigTable, column-oriented databases, in memory databases, or clustered databases. External service 304 comprises web-enabled services or functionality related to or installed on a computing device 107 itself which may be deployed on one or more of a particular enterprise's or user's premises. Configuration system 305 comprises a system common to information technology (IT) and web functions that implements configurations or management systems. Security system 306 comprises a system common to information technology (IT) and web functions that implements security related functions for the system. Distributed computing network 307 comprises any number of client 302 and/or server 301 operably connected to a communications network 104 for the purposes of implementing the system.

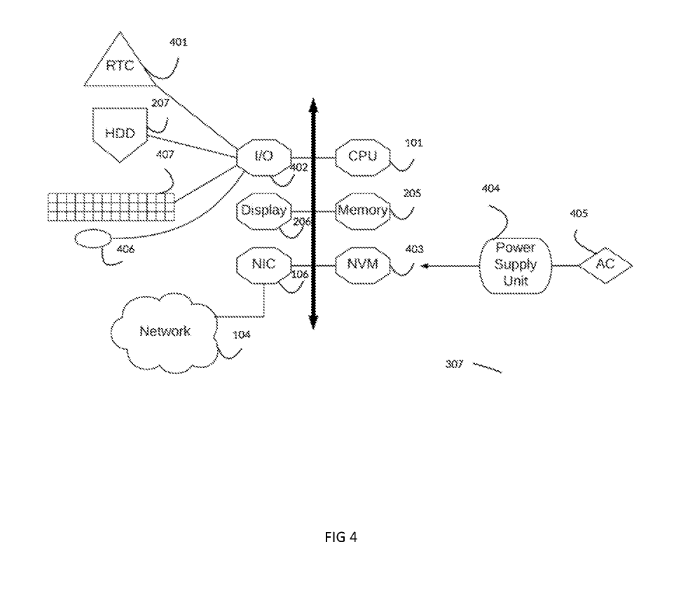

Referring now to FIG. 4, which shows a diagram that shows an embodiment of a hardware architecture of a computing device used in various embodiments of the invention. Real time clock 401 comprises a computer device clock (most often in the form of an integrated circuit) that keeps track of the current time. Input output units 402 comprises devices used by a human (or other system) to communicate with a computer. Non volatile memory 403 comprises computer memory 205 that can retrieve stored information even after having been power cycled (turned off and back on). Power supply 404 comprises an electronic device that supplies electric energy to an electrical load. In some embodiments, it is thought that an example of power source 405 could be AC power or perhaps DC power and the like.

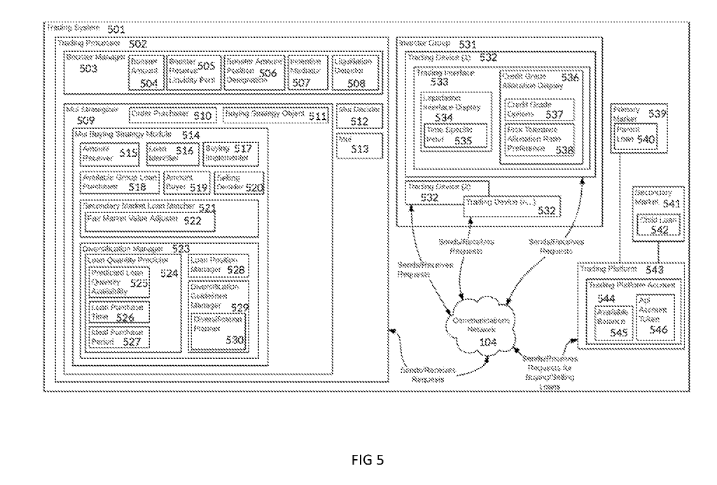

Referring now to FIG. 5, which shows a systems diagram of the distributed computing network. Trading system 501 comprises a distributed computing network 307 that increases liquidity by establishing an investor group 531 who have agreed to buy secondary market loans from other members of the group. Trading system 501 preferably comprises trading device 532, trading platform 543, and finally, trading processor 502.

Trading platform 543 comprises a third party management system of one or more server 301 that allows the user to be able to buy and sell loans from primary market 539 or secondary market 541. In some embodiments, it is thought that if trading platform 543 is absent, then the trading system 501 may itself incorporate a mechanism that allows the user to be able to buy and sell loans. Trading platform 543 preferably comprises trading platform account 544. Trading device 532 comprises a computing device 107 that implements the user portions of the trading system 501 through a communications network 104. Trading device 532 preferably comprises trading interface 533. Trading processor 502 comprises one or more server 301 that operably communicates over a communications network 104 that performs storage processing connecting and distributing functions for the trading system 501 and operably communicates with one or more trading device 532 as part of the investor group 531. Trading processor 502 preferably comprises MUI strategizer 509, MUI decider 512, MUI 513, and finally, booster manager 503.

Trading platform account 544 comprises one or modules that manage the repository of investor information linked to one or members of an investor group 531. Trading platform account 544 comprises available balance 545 and API account token 546. Available balance 545 comprises one or modules that manages the amount of money available to purchase loans or securities. API account token 546 comprises a unique identification token that uniquely identifies a member of the investor group 531 as being part of the trading platform 543 and operably links to the trading processor 502 and/or trading device 532.

Trading interface 533 comprises a financial application that mediates the interactions of the investor group 531. Trading interface 533 comprises credit grade allocation display 536 and liquidation interface display 534. Credit grade allocation display 536 comprises a graphical user interface 106 where people are presented with credit grade options 537. Credit grade allocation display 536 comprises risk tolerance allocation ratio preference 538 and credit grade options 537. Liquidation interface display 534 comprises program instructions for receiving indication of liquidation amount. Liquidation interface display 534 preferably comprises time specific input 535.

Risk tolerance allocation ratio preference 538 comprises parameters data submitted by an end user that determines the future purchasing behavior of the trading system 501. In some embodiments, it is thought that if risk tolerance allocation ratio preference 538 is absent, then a user may have a predefined risk tolerance, for example, by choosing only one credit risk bucket. Credit grade options 537 comprises displays on trading interface 533 of one or more buckets of credit risks with anticipated return rates. Time specific input 535 comprises a module for receiving indication of a time specific liquidation parameter within which liquidation requests should be completed for a liquidation amount.

MUI 513 comprises program instructions for storage of agreed upon amount upon which members of the investor group 531 will purchase loans in increments thereof. The micro-unit increment is an acronym which stands for MUI 513. MUI decider 512 comprises program instructions that determine the MUI 513 for a specific trading platform 543 by input or confirmation from one more admin or existing investor group 531 member. MUI strategizer 509 comprises a module or program instructions that in the event of a sale of one or more loans made available via said trading platform 543 wherein the sale is initiated by a single computing device 107 identified as a member of the investor group 531, the program instructions prioritize the iterative purchase of loans for other members of the investor group 531 in order to increase liquidity of the investor group 531. MUI strategizer 509 preferably comprises MUI buying strategy module 514, buying strategy object 511, and finally, order purchaser 510. Booster manager 503 comprises a module that mediates and organizes program instructions for the booster reserve liquidity pool 505 and that creates a reserve liquidity pool for time specific liquidation wherein said liquidity pool is made up of funds set aside from a portion of one or more members of the investor group available balance. Booster manager 503 preferably comprises booster amount 504, booster amount position designation 506, booster reserve liquidity pool 505, liquidation detector 508, and finally, incentive mediator 507.

MUI buying strategy module 514 comprises a module that determines via algorithm the purchasing strategy that considers the diversification strategy relative to the account balance of the buyer and the liquidation amount of the seller, in order to preferentially examine the secondary market before the primary market, in order to increase liquidity of an investor group 531. MUI buying strategy module 514 preferably comprises diversification manager 523, selling decider 520, amount receiver 515, amount buyer 519, loan identifier 516, secondary market loan matcher 521, available group loan purchaser 518, and finally, buying implementer 517. Buying strategy object 511 comprises a data object that is a result of the MUI 513 buying strategy that determines the future purchasing strategy that will be implemented by a user. Order purchaser 510 comprises one or module that uses a buying strategy object in order to implement purchases on a trading platform 543.

Amount receiver 515 comprises a module that receives indication of liquidation amount as a determination that a member of an investor group 531 wants to liquidate a loan or position for the liquidation amount. Amount buyer 519 comprises a module for converting a liquidation amount into a buying amount. Loan identifier 516 comprises a module for identifying purchasing available group loans demarcated for expedited liquidation from a member of the investor group 531. Available group loan purchaser 518 comprises a module that purchases available group loans for the liquidation amount. Secondary market loan matcher 521 comprises a module for examining one or more available group loans on a secondary market 541 that match the diversification strategy and the member's risk tolerance input. Selling decider 520 comprises a module that determines the existence of qualifying investor group loans. Buying implementer 517 comprises a module for implementing a buying strategy in the event that available group loans on secondary market 541 are available and match the diversification strategy and member risk tolerance input. Buying implementer 517 preferably comprises fair market value adjuster 522. Fair market value adjuster 522 comprises a module that adjusts the loan to current fair market value of like credit grade of the primary market 539. Diversification manager 523 comprises program instructions that implement a diversification strategy for purchasing according to an available balance. Diversification manager 523 preferably comprises loan quantity predictor 524, diversification guidelines manager 529, and finally, loan position manager 528.

Diversification guidelines manager 529 comprises a module that implements loan purchased from one or more investors of investor group 531 on trading platform 543 configured to the diversification strategy of an individual member of investor group 531 in MUI 513.

Diversification guidelines manager 529 preferably comprises diversification planner 530. Diversification planner 530 comprises a module that initiates implementation of a diversification strategy. Diversification planner 530 has multiple alternative embodiments herein termed “non optimum MUI transaction” embodiment, “optimum MUI transaction” embodiment, and “diversification threshold” embodiment. “Non optimum MUI transaction” embodiment comprises a MUI 513 buying strategy which is the lesser of the optimum MUI transaction and the ideal purchase period 527. In some embodiments, it is a strategy to purchase more than one MUI 513 per loan (in contrast to the optimum MUI transaction) in order to ensure liquidation to one or more investor group 531 members and decrease the time to deploy the user's capital. “Optimum MUI transaction” embodiment comprises a MUI 513 buying strategy which, in theory, has the best possible diversification. In some embodiments, it represents only one stake or note of a MUI 513 per loan, when multiple loans are purchased as part of a buying strategy. “Diversification threshold” embodiment comprises a MUI 513 buying strategy which, in theory, has the best possible diversification. In some embodiments, it represents only one stake or note of a MUI 513 per loan, when multiple loans are purchased as part of a buying strategy.

Loan position manager 528 comprises a module that evaluates what notes to sell from a user and that chooses which notes best matches the particular optimum diversification for the people who are buying. Loan quantity predictor 524 comprises a module that, in some embodiments, predicts the likely quantity of loans available determined by the risk tolerance allocation ratio preference and the predicted loan quantity availability 525. Loan quantity predictor 524 preferably comprises loan purchase time 526, ideal purchase period 527, and finally, predicted loan quantity availability 525.

Loan purchase time 526 comprises calculated data object that references the amount of time to purchase available loans based on the optimum MUI 513 buying strategy. Predicted loan quantity availability 525 comprises data object that predicts the future availability of loans based on the user's risk tolerance allocation ratio preference. Ideal purchase period 527 comprises data object containing the time to invest a person's money based on their risk tolerance allocation ratio preference, compared to the loan purchase time 526 as part of the MUI 513 buying strategy.

Booster amount 504 comprises money from new members that is held for Booster Reserve Liquidity Pool. Booster amount position designation 506 comprises an indication of which order the booster amount 504 was received in an overall pool. Booster reserve liquidity pool 505 comprises money specifically designated for set timeline liquidations. Liquidation detector 508 comprises a module for detecting whether time specific parameters will be met, and if not met, the remaining balance is liquidated through the booster reserve liquidity pool 505. Incentive mediator 507 comprises a module that decreases individual child loan 542 amounts from a current member according to an incentive parameter for funding booster reserve liquidity pool 505.

Investor group 531 comprises a plurality of investors that agree to be part of the trading system 501 as a selected set or plurality of one or more computing device 107 operably connected to communications network 104. Primary market 539 comprises the loan originator, made available through the trading platform 543, which has one or more parent loan 540. Parent loan 540 comprises the whole loan, as offered on the primary market. Secondary market 541 comprises child loan 542 originally purchased on primary market 539 for resale via the trading system 501. Child loan 542 comprises a fractional position of the parent loan 540, which is purchased in MUI 513 by the investor group 531.

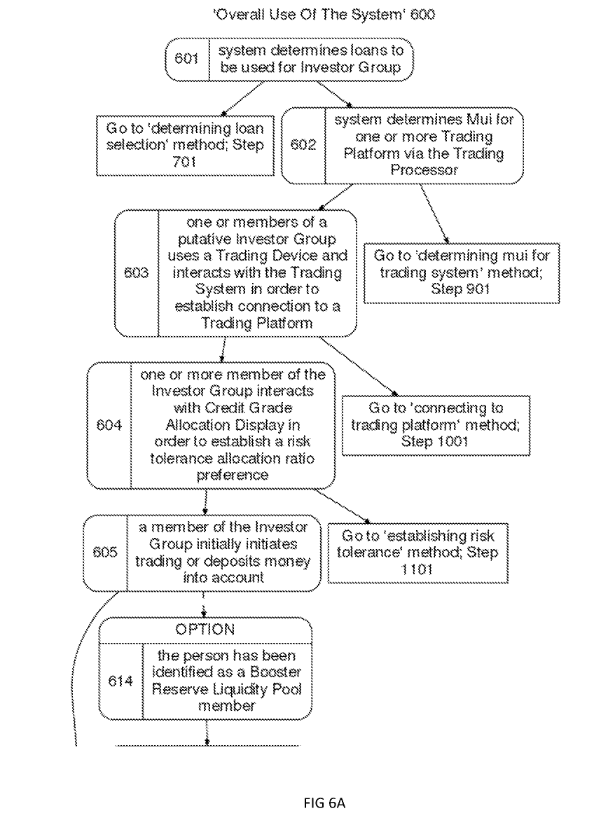

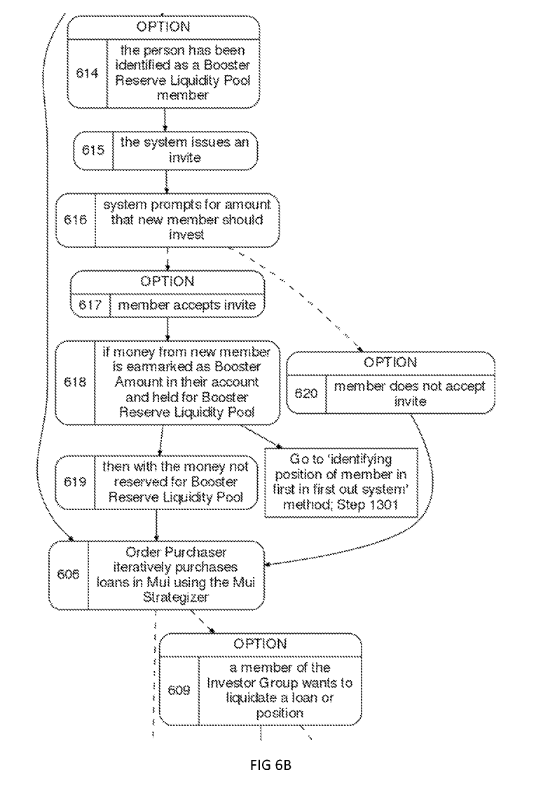

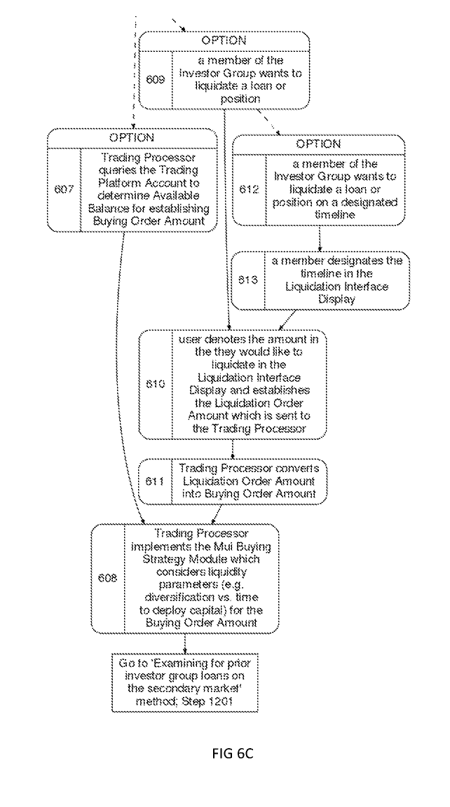

Referring now to FIG. 6, which shows overall use of the system. In a first step, system determines loans to be used for investor group 531 (Step 601). Step 601 is further detailed below in a related method (700—‘determining loan selection’). Next, system determines MUI 513 for one or more trading platform 543 via the trading processor 502 (Step 602). Step 602 is further detailed below in a related method (900—‘determining MUI for trading system’).

Next, one or members of a putative investor group 531 uses a trading device 532 and interacts with the trading system 501 in order to establish connection to a trading platform 543 (Step 603). Step 603 is further detailed below in a related method (1000—‘connecting to trading platform’).

Next, one or more member of the investor group 531 interacts with credit grade allocation display 536 in order to establish a risk tolerance allocation ratio preference (Step 604). Step 604 is further detailed below in a related method (1100—‘establishing risk tolerance’).

Next, a member of the investor group 531 initially initiates trading or deposits money into account (Step 605). Next, order purchaser 510 iteratively purchases loans in MUI 513 using the MUI strategizer 509 (Step 606). If trading processor 502 queries the trading platform account 544 to determine available balance 545 for establishing buying order amount (Step 607), then trading processor 502 implements the MUI buying strategy module 514 which considers liquidity parameters (e.g. diversification vs. time to deploy capital) for the buying order amount (Step 608). Step 608 is further detailed below in a related method (1200—‘Examining for prior investor group loans on the secondary market’).

From Step 606, if a member of the investor group 531 wants to liquidate a loan or position (Step 609), then user denotes the amount in the they would like to liquidate in the liquidation interface display 534 and establishes the liquidation order amount which is sent to the trading processor 502 (Step 610). Next, trading processor 502 converts liquidation order amount into buying order amount (Step 611). Next, refer to Step 608.

From Step 609, if a member of the investor group 531 wants to liquidate a loan or position on a designated timeline (Step 612), then a member designates the timeline in the liquidation interface display 534 (Step 613). Next, refer to Step 610.

From Step 605, if the person has been identified as a booster reserve liquidity pool 505 member (Step 614), then the system issues an invite (Step 615). Next, system prompts for amount that new member should invest (Step 616). If member accepts invite (Step 617), then if money from new member is earmarked as booster amount 504 in their account and held for booster reserve liquidity pool 505 (Step 618), then with the money not reserved for booster reserve liquidity pool 505 (Step 619), next, refer to Step 606. Step 618 is further detailed below in a related method (1300—‘identifying position of member in first in first out system’). Next, From Step 616, if member does not accept invite (Step 620), then refer to Step 606.

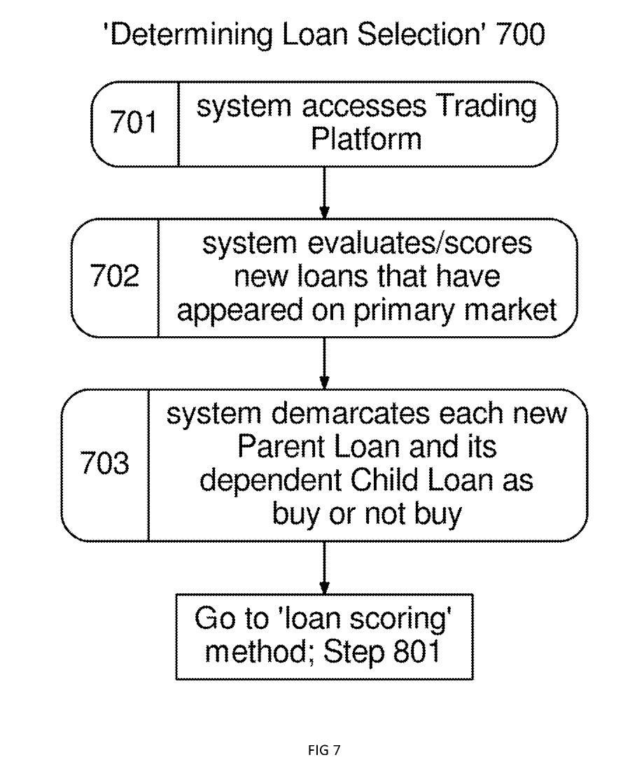

Referring now to FIG. 7, which shows determining loan selection. In a first step, system accesses trading platform 543 (Step 701). Next, system evaluates/scores new loans that have appeared on primary market (Step 702). Next, system demarcates each new parent loan 540 and its dependent child loan 542 as buy or not buy (Step 703). Step 703 is further detailed below in a related method (800—‘loan scoring’).

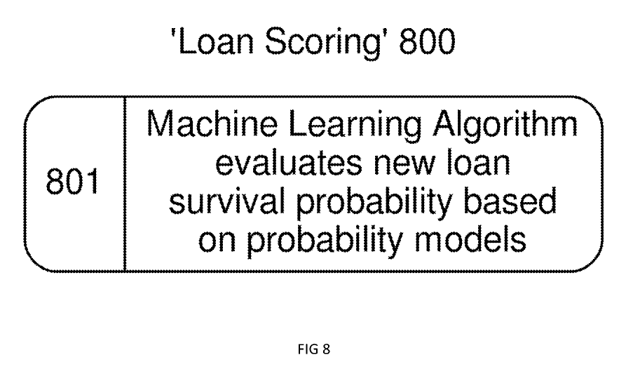

Referring now to FIG. 8, which shows loan scoring. In a first step, machine learning algorithm evaluates new loan survival probability based on probability models (Step 801).

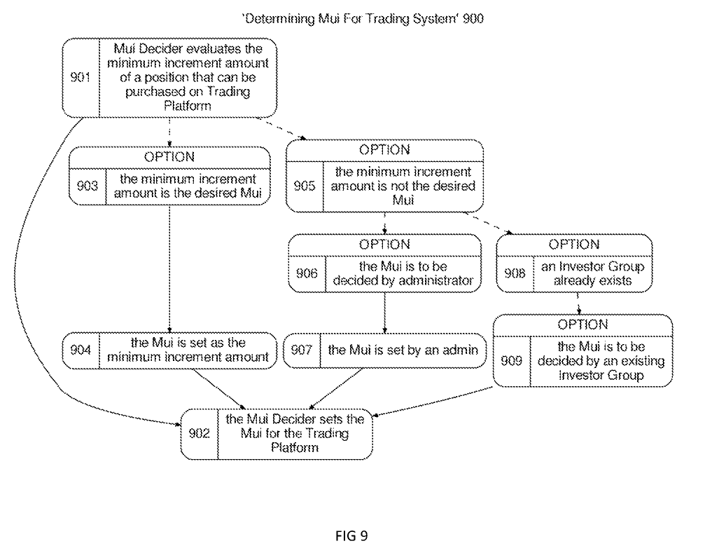

Referring now to FIG. 9, which shows determining MUI for trading system. In a first step, MUI decider 512 evaluates the minimum increment amount of a position that can be purchased on trading platform 543 (Step 901). Next, the MUI decider 512 sets the MUI 513 for the trading platform 543 (Step 902).

From Step 901, if the minimum increment amount is the desired MUI 513 (Step 903), then the MUI 513 is set as the minimum increment amount (Step 904). Next, refer to Step 902.

From Step 901, if the minimum increment amount is not the desired MUI 513 (Step 905), and if the MUI 513 is to be decided by administrator (Step 906), then the MUI 513 is set by an admin (Step 907). Next, refer to Step 902.

From Step 905, if an investor group 531 already exists (Step 908), and if the MUI 513 is to be decided by an existing investor group 531 (Step 909), then refer to Step 902.

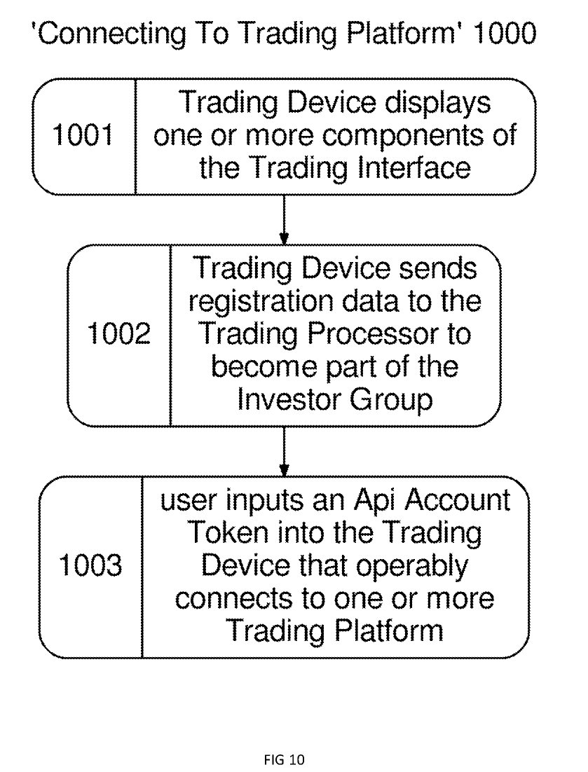

Referring now to FIG. 10, which shows connecting to trading platform. In a first step, trading device 532 displays one or more components of the trading interface 533 (Step 1001). Next, trading device 532 sends registration data to the trading processor 502 to become part of the investor group 531 (Step 1002). Next, user inputs an API account token 546 into the trading device 532 that operably connects to one or more trading platform 543 (Step 1003).

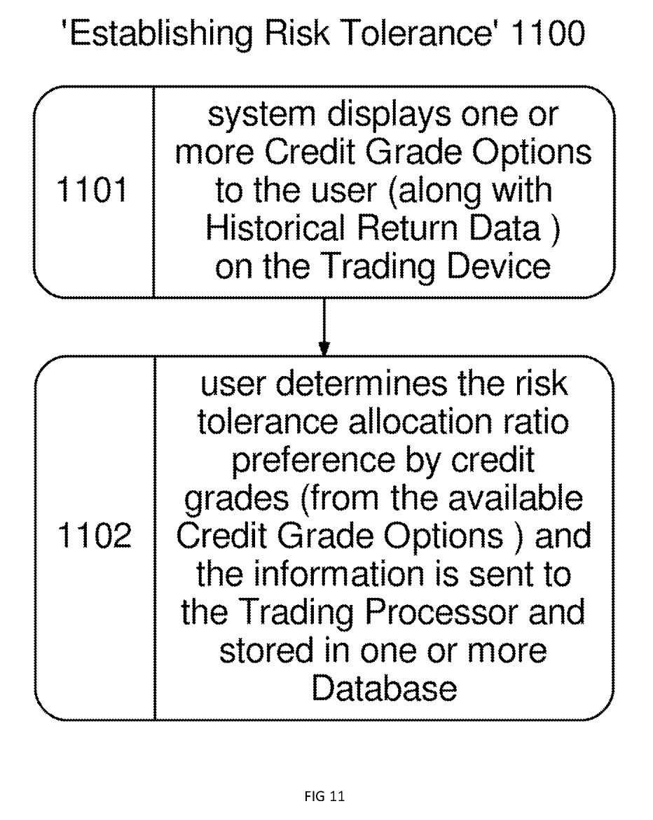

Referring now to FIG. 11, which shows establishing risk tolerance. In a first step, system displays one or more credit grade options 537 to the user (along with historical return data) on the trading device 532 (Step 1101). Next, user determines the risk tolerance allocation ratio preference by credit grades (from the available credit grade options 537) and the information is sent to the trading processor 502 and stored in one or more database 303 (Step 1102).

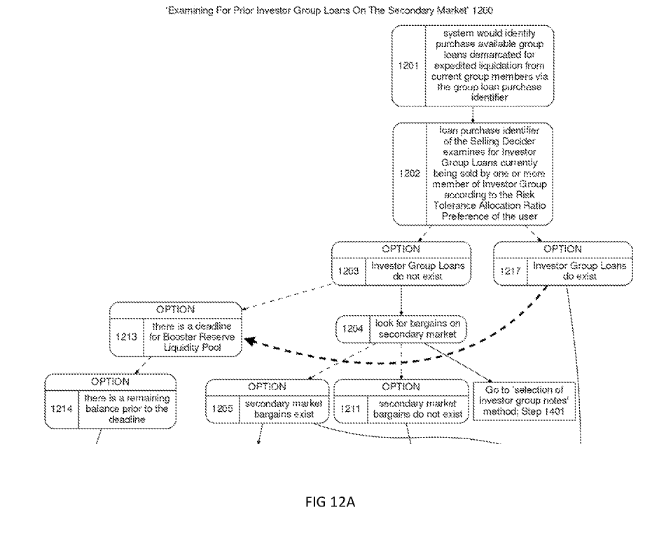

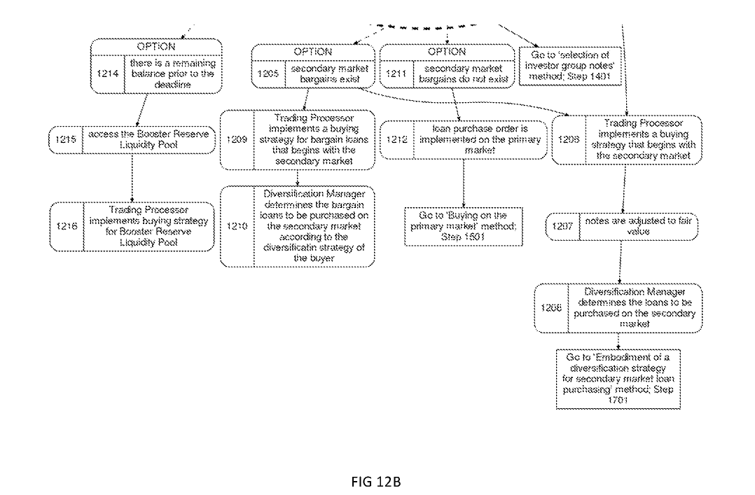

Referring now to FIG. 12, which shows examining for prior investor group loans on the secondary market. In a first step, system would identify purchase available group loans demarcated for expedited liquidation from current group members via the group loan purchase identifier (Step 1201). Next, loan purchase identifier of the selling decider 520 examines for investor group loans currently being sold by one or more member of investor group 531 according to the risk tolerance allocation ratio preference 538 of the user (Step 1202). If investor group loans do not exist (Step 1203), then look for bargains on secondary market (Step 1204). Step 1204 is further detailed below in a related method (1400—‘selection of investor group notes’).

If secondary market bargains exist (Step 1205), then trading processor 502 implements a buying strategy that begins with the secondary market (Step 1206). Next, notes are adjusted to fair value (Step 1207). Next, diversification manager 523 determines the loans to be purchased on the secondary market (Step 1208). Step 1208 is further detailed below in a related method (1700—‘an embodiment of a diversification strategy for secondary market loan purchasing’).

From Step 1205, next, trading processor 502 implements a buying strategy for bargain loans that begins with the secondary market (Step 1209). Next, diversification manager 523 determines the bargain loans to be purchased on the secondary market according to the diversification strategy of the buyer (Step 1210).

From Step 1204, if secondary market bargains do not exist (Step 1211), then loan purchase order is implemented on the primary market (Step 1212). Step 1212 is further detailed below in a related method (1500—‘Buying on the primary market’).

From Step 1203, if there is a deadline for booster reserve liquidity pool 505 (Step 1213), and if there is a remaining balance prior to the deadline (Step 1214), then access the booster reserve liquidity pool 505 (Step 1215). Next, trading processor 502 implements buying strategy for booster reserve liquidity pool 505 (Step 1216).

From Step 1202, if investor group loans do exist (Step 1217), and if there is a deadline for boosting reserve liquidity pool 505, proceed to Step 1213, else refer to Step 1206.

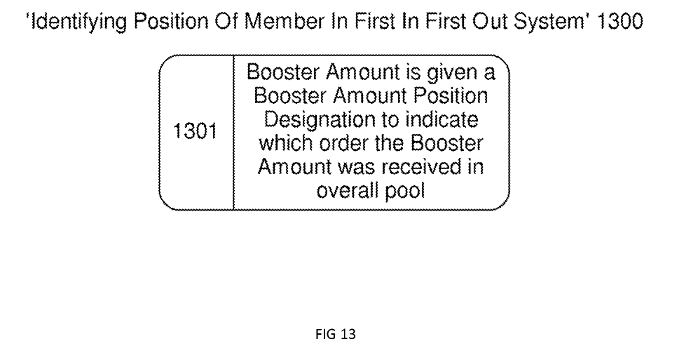

Referring now to FIG. 13, which shows identifying position of member in first in first out system. In a first step, booster amount 504 is given a booster amount position designation 506 to indicate which order the booster amount 504 was received in overall pool (Step 1301).

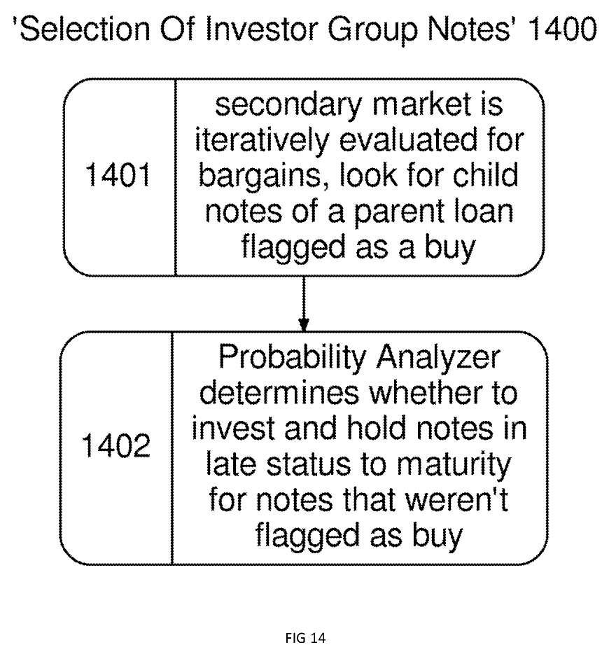

Referring now to FIG. 14, which shows selection of investor group notes. In a first step, secondary market is iteratively evaluated for bargains, looking for child notes of a parent loan flagged as a buy (Step 1401). Next, probability analyzer determines whether to invest and hold notes in late status to maturity for notes that weren't flagged as buy (Step 1402).

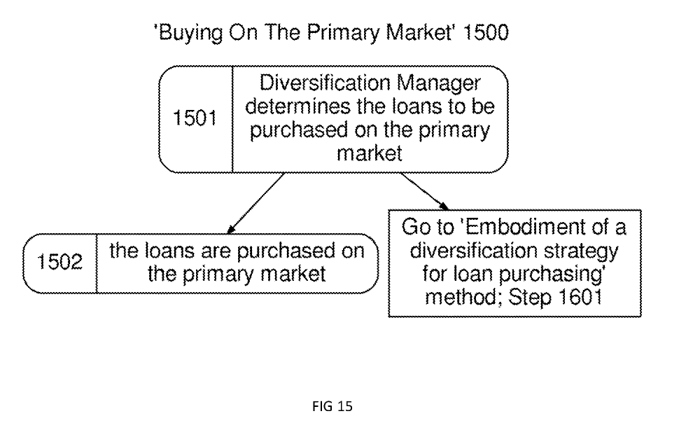

Referring now to FIG. 15, which shows buying on the primary market. In a first step, diversification manager 523 determines the loans to be purchased on the primary market (Step 1501). Step 1501 is further detailed below in a related method (1600—‘an embodiment of a diversification strategy for loan purchasing’). Next, the loans are purchased on the primary market (Step 1502).

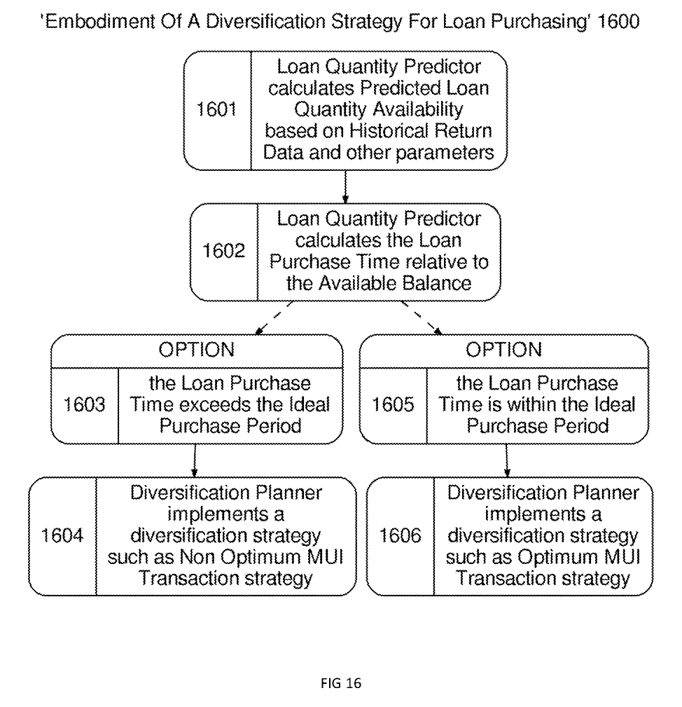

Referring now to FIG. 16, which shows an embodiment of a diversification strategy for loan purchasing. In a first step, loan quantity predictor 524 calculates predicted loan quantity availability 525 based on historical return data and other parameters (Step 1601). Next, loan quantity predictor 524 calculates the loan purchase time 526 relative to the available balance 545 (Step 1602). If the loan purchase time 526 exceeds the ideal purchase period 527 (Step 1603), then diversification planner 530 implements a diversification strategy such as non optimum MUI transaction strategy (Step 1604).

From Step 1602, if the loan purchase time 526 is within the ideal purchase period 527 (Step 1605), then diversification planner 530 implements a diversification strategy such as optimum MUI transaction strategy (Step 1606).

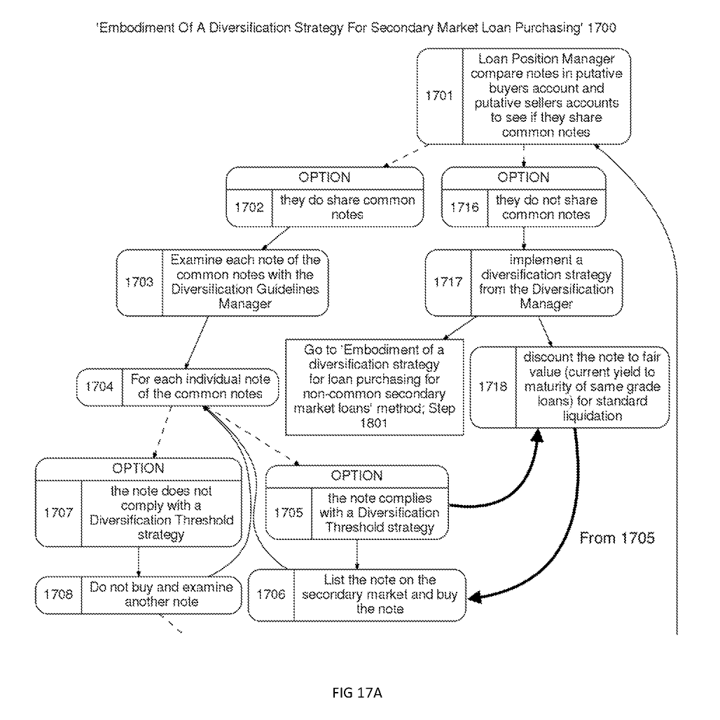

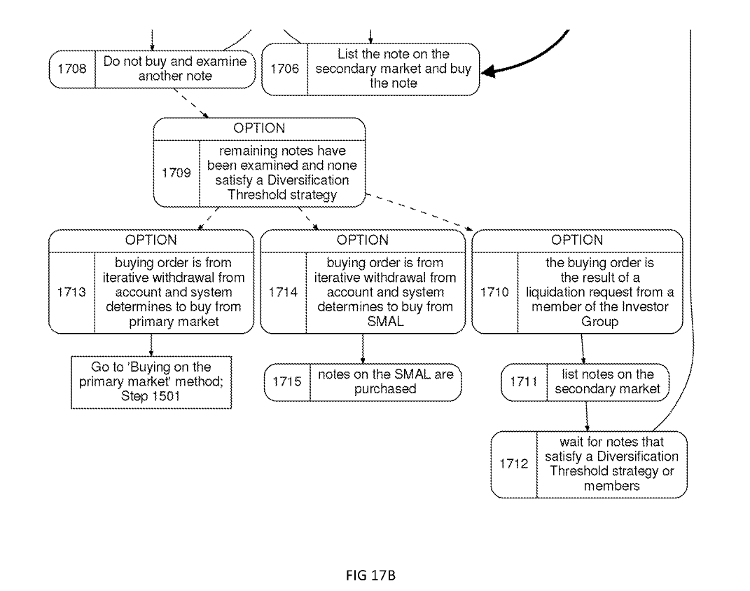

Referring now to FIG. 17, which shows an embodiment of a diversification strategy for secondary market loan purchasing. In a first step, loan position manager 528 compares notes in putative buyers' accounts and putative seller's accounts to see if they share common notes (Step 1701). If they do share common notes (Step 1702), then examine each note of the common notes with the diversification guidelines manager 529 (Step 1703). Next, For each individual note of the common notes (Step 1704), if the note complies with a diversification threshold strategy (Step 1705), then proceed to Step 1718, then list the note on the secondary market and buy the note (Step 1706). Next, refer to Step 1704.

If the note does not comply with a diversification threshold strategy (Step 1707), then do not buy and examine another note (Step 1708). If remaining notes have been examined and none satisfy a diversification threshold strategy (Step 1709), and if the buying order is the result of a liquidation request from a member of the investor group 531 (Step 1710), then list notes on the secondary market (Step 1711). Next, wait for notes that satisfy a diversification threshold strategy of members (Step 1712). Next, refer to Step 1701.

From Step 1709, if buying order is from iterative withdrawal from account and system determines to buy from primary market (Step 1713), then refer to Step 1500 (‘buying on the primary market’).

From Step 1709, if buying order is from iterative withdrawal from account and system determines to buy from SMAL (secondary market at large) (Step 1714), then notes on the SMAL are purchased (Step 1715).

From Step 1701, if they do not share common notes (Step 1716), then implement a diversification strategy from the diversification manager 523 (Step 1717). Step 1717 is further detailed below in a related method (1800—‘an embodiment of a diversification strategy for loan purchasing for non-common secondary market loans’). Next, discount the note to fair value (current yield to maturity of same grade loans) for standard liquidation (Step 1718).

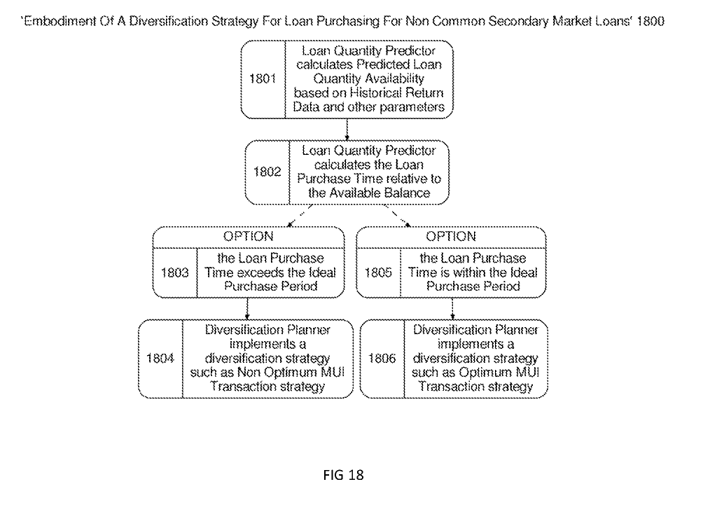

Referring now to FIG. 18, which shows an embodiment of a diversification strategy for loan purchasing for non-common secondary market loans. In a first step, loan quantity predictor 524 calculates predicted loan quantity availability 525 based on historical return data and other parameters (Step 1801). Next, loan quantity predictor 524 calculates the loan purchase time 526 relative to the available balance 545 (Step 1802). If the loan purchase time 526 exceeds the ideal purchase period 527 (Step 1803), then diversification planner 530 implements a diversification strategy such as non optimum MUI transaction strategy (Step 1804).

From Step 1802, if the loan purchase time 526 is within the ideal purchase period 527 (Step 1805), then diversification planner 530 implements a diversification strategy such as optimum MUI transaction strategy (Step 1806).

The following elements and/or terms investor group loans, historical return data, buying order amount, liquidation order amount, probability analyzer, machine learning algorithm physical ports, independent processor, interface memory, NIC, busses, touchscreen, microphone, touchpad, trackball, program instructions, and system server, are important for the working functionality, but do not appear in the drawings and are shown below.

Investor group loans comprises data that identifies the loans listed by the investor group 531.

Historical return data comprises one or more data object containing expected return on a specific credit grade options 537 presented for use.

Buying order amount comprises one or more data objects or properties that is indicative of the amount that the MUI strategizer 509 is tasked with purchasing.

Liquidation order amount comprises one or more data objects or properties that is indicative of the amount that an investor group 531 member wants to liquidate.

Probability analyzer comprises determining whether to invest and hold notes in late status to maturity for notes that weren't flagged as buy.

Machine learning algorithm comprises a module that evaluates new loan survival probability based on probability models.

In some embodiments, it is thought that an example of independent processor could be audio processor or perhaps video processor and the like.

In some embodiments, it is thought that an example of interface memory may include volatile and/or non-volatile memory 205 (e.g., RAM) and the like.

NIC comprises a computer hardware component that connects a computer to a computer network.

Busses comprises a communication system that transfers data between components inside a computer, or between computers.

Program instructions comprises a mechanism for control execution of system, or comprising of an operating systems 203, and/or one or more applications. In some embodiments, it is thought that examples of program instructions may include: code produced by a compiler, object code, machine code, code produced by an assembler or a linker, byte code, code executed using an interpreter, or code on local memo.

System server comprises a computing device 107 typically used to communicate with a plurality of other computing devices through communications protocols.

I claim:

1. A distributed computing network system comprising:
a communications network;
one or more first server configured to handle requests received from one or more second server over said communications network;
wherein said one or more first server is a third-party management system that allows users to buy and sell loans from a primary market or secondary market;
wherein said primary market is the loan originator, made available through said management system, which has one or more parent loan;
wherein said secondary market comprises a child loan originally purchased on said primary market for resale via said trading system;
wherein said management system comprises one or more management system account;
wherein said management system account comprises one or more available balance;
wherein said management system account comprises one or more unique identification token for one or more member of an investor group;
wherein said second server operably communicates with said first server and is configured to handle requests from said investor group;
wherein said investor group comprises a selected set of computing device that send and receive requests from at least said second server over said communications network;
wherein said second server comprises second server memory;
wherein said second server memory comprises a micro-unit increment strategizer;
wherein said micro-unit increment strategizer comprises program instructions that in the event of a sale of one or more loans made available via said third party management system;
wherein said sale was initiated by a single computing device identified as a member of said investor group;
wherein said micro-unit increment strategizer prioritizes the iterative purchase of said loans for other members of said investor group in order to increase the liquidity of said members of said investor group.

2. The system of claim 1, wherein said second server memory comprises a micro-unit increment;
wherein said micro-unit increment are program instructions for storage of an agreed upon amount upon which said investor group will purchase said loans in increments thereof.

3. The system of claim 2, wherein said second server memory comprises a micro unit increment decider;
wherein said micro unit increment decider are program instructions that determine said micro unit increment for one or more said third party management system by input or confirmation for one or more said member of said investor group.

4. The system of claim 3, wherein one or more of said computing device of said investor group computing device memory comprises a trading interface;
wherein said trading interface comprises program instructions for displaying a financial application that present credit grade options stored on said trading processor for receiving risk tolerance selection input.

5. The system of claim 4, wherein said second server memory comprises a diversification manager;
wherein said diversification manager are program instructions that implement a diversification strategy for purchasing according to said available balance.

6. The system of claim 5, wherein said second server memory comprises a micro-unit increment buying strategy module;
wherein said micro-unit increment buying strategy module are program instructions that determine the algorithm for the purchasing strategy that considers said diversification strategy relative to said available balance of the buyer and the liquidation amount of the seller in order to preferentially examine said secondary market before said primary market in order to increase liquidity of said investor group.

7. The system of claim 6, wherein said second server memory comprises a diversification guidelines manager;
wherein said diversification guidelines manager comprises program instructions for an order purchase that uses one or more modules to implement loan purchases for one or more member of said investor group on said trading platform, configured to the diversification strategy of an individual member of said investor group in said micro unit increment.

8. The system of claim 7, wherein one of said computing device of said investor group comprises a liquidation interface display;
wherein said liquidation interface display are program instructions for receiving an indication of a liquidation amount.

9. The system of claim 8, wherein said second server memory comprises an amount receiver;
wherein said amount receiver receives said indication of said liquidation amount as a determination that a member of said investor group wants to liquidate a loan or position for said liquidation amount.

10. The system of claim 9, wherein said second server memory comprises an amount buyer;
wherein said amount buyer comprises program instructions for converting said liquidation amount into a buying order amount.

11. The system of claim 10, wherein said second server memory comprises a loan identifier;
wherein said loan identifier comprises program instructions for identifying purchasing available group loans demarcated for expedited liquidation from current member of said investor group.

12. The system of claim 11, wherein said second server memory comprises a secondary market loan matcher;
wherein said secondary market loan matcher comprises program instructions for examining one or more said available group loans on said secondary market that match said diversification strategy and said current member risk tolerance input.

13. The system of claim 12, wherein said second server memory comprises a buying implementer;
wherein said buying implementer comprises program instructions for implementing a buying strategy in the event that said available group loans on said secondary market are available and match said diversification strategy and said current member risk tolerance input.

14. The system of claim 13, wherein said second server memory comprises a fair market value adjuster;
wherein said fair market value adjuster are program instructions for adjusting the loan to current fair market value of like credit grade on said primary market.

15. The system of claim 14, wherein said second server memory comprises an available group loan purchaser;
wherein said available group loan purchaser are program instructions for purchasing said available group loans for the said liquidation amount.

16. The system of claim 8, wherein one of said computing device of said investor group comprises a time-specific input;
where time-specific input comprises program instructions for receiving a time-specific liquidation parameter within which liquidation requests should be completed for said liquidation amount.

17. The system of claim 16, wherein said second server memory comprises a booster manager;
wherein said booster manager comprises program instructions for creation of a reserve liquidity pool for time-specific liquidation;
wherein said liquidity pool is made up of funds set aside from a portion of one or more members of said investor group said available balance;

18. The system of claim 17, wherein said second server memory comprises programmatic instructions that receives said indication of said liquidation amount as a determination that a member of said investor group wants to liquidate a loan or position for said liquidation amount;
wherein said second server memory comprises programmatic instructions for converting said liquidation amount into a buying order amount;
wherein said second server memory comprises programmatic instructions for identifying purchasing available group loans demarcated for expedited liquidation from current member of said investor group;
wherein said second server memory comprises programmatic instructions for examining one or more said available group loans on said secondary market that match said diversification strategy and said current member risk tolerance input;
wherein said second server memory comprises programmatic instructions for implementing a buying strategy in the event that said available group loans on said secondary market are available and match said diversification strategy and said current member risk tolerance input;
wherein said buying strategy comprises programmatic instructions for adjusting the loan to current fair market value of like credit grade on said primary market;
wherein said second server memory comprises programmatic instructions for purchasing said available group loans for the said liquidation amount.

19. The system of claim 18, wherein said second server memory comprises a liquidation detector;
wherein said liquidation detector are program instructions for detecting whether said time-specific liquidation parameter will be met and if not met, the remaining balance will be liquidated through said reserve liquidity pool.

20. The system of claim 19, wherein said second server memory comprises an incentive mediator;
wherein said incentive mediator comprises program instructions for decreasing individual said child loan amounts from said current member according to an incentive parameter for funding said liquidity pool.
